(19) United States
(12) Patent Application Publication
(10) Pub. No.: US 2003/0025435 A1
(43) Pub. Date: Feb. 6, 2003

(54) Reservoir dispenser cathode and method of manufacture

(76) Inventor: Bernard K. Vancil, Beaverton, OR (US)

Correspondence Address: DELLETT AND WALTERS, 310 S.W. FOURTH AVENUE, SUITE 1101, PORTLAND, OR, 97204, US

(21) Appl. No.: 10/264,355

(22) Filed: Oct. 3, 2002

Related U.S. Application Data
(63) Continuation-in-part of application No. 09/448,665, filed on Nov. 24, 1999.

(51) Int. Cl. H01J 1/28; H01J 1/26

(52) U.S. Cl. 313/346 DC

(57) ABSTRACT

A reservoir dispenser cathode includes a cup for receiving a material adapted to decompose when heated which passes to the upper surface of a porous plug at the top of the cup and coats this surface, thus producing a low work function surface. The plug may include a circumferential band while the cup has a radial flange resting on a cylindrical heater body and extending therebeyond. The flange is employed as a welding material for providing a continuous circumferential weld. To produce the weld, a laser is directed to the seam between the flange and the heater body while the assembly of the cup, flange and heater body is rotated around a common axis. The weld provides a hermetic seal between cup and plug and is accomplished without impairment of the emissive material or the plug.

BACKGROUND OF THE INVENTION

This application is a continuation-in-part of my U.S. patent application Ser. No. 09/448,665, filed Nov. 24, 1999, and entitled “Reservoir Dispenser Cathode and Method of Manufacture”.

The present invention relates to a reservoir dispenser cathode and particularly to a miniaturized dispenser cathode for providing high emission current density over an extended period of time.

In display cathode ray tubes such as used for computer terminals, the information density and resolution are determined by spot size on the cathode ray tube screen, in turn governed by electron beam current density. Dispenser cathodes comprising a refractory metal matrix impregnated with an electron emissive material are capable of high emission but their life span is reduced at high current densities. A reservoir dispenser cathode in which the electron emissive material is located in a cavity behind a porous metal matrix or diffuser plug has been shown to provide much longer life operation. However, difficulties in construction arise relating to securing the porous metal matrix to the reservoir body. Thus, the emissive pellet or plug is twenty to thirty percent porous and simply welding or brazing the porous pellet to a cup defining the reservoir tends to destroy the porous plug. If, on the other hand, the porous plug is merely pressed into the reservoir cup or secured thereto at a number of separate points, the electron emissive material leaks, i.e., insubstantial vapor pressure is built up within the reservoir as would cause the electron emissive material to effectively reach the emissive surface of the plug. Therefore, relatively complex and expensive constructions need to be employed which not only increase the cost of the device and result in less efficient mass production, but also render miniaturization less attainable.

### SUMMARY OF THE INVENTION

In accordance with the present invention in a preferred embodiment thereof, a reservoir dispenser cathode includes an upwardly open refractory metal cup for receiving therewithin a material adapted to decompose when heated and provide a product having a low work function. A porous refractory metal body or diffuser plug, preferably including a surrounding band member or collar, closes off the upper opening of the cup and is adapted to pass electron emissive substance therethrough. The cup, where it supports the porous metal body, is provided with a radial flange extending outwardly from the top of the cup. A filament receiving, cylindrical, heater body is disposed in supporting relation to the lower side of the cup flange, wherein the cup flange extends radially outwardly from the heater body by a distance comparable to the thickness of the heater body. The flange is used as a weld material wherein the portion of the flange extending outwardly from the heater body and the plug produces a circumferential weldment bead joining the plug and the heater body to the intermediate cup in sealing relation. This weldment bead is formed in continuous fashion employing a laser welder with a rotational fixture. A laser beam directed toward the seam between the plug, the cup and the heater body easily secures the components together with neither destruction of the porous plug material nor incomplete joinder as would allow a reduction of vapor pressure within the reservoir defined by the cup. The structure described can be mass produced inexpensively in small sizes and is observed to provide electron emissions at high current density for periods several times as long as conventional dispenser cathodes of the non-reservoir type.

It is accordingly an object of the present invention to provide an improved reservoir dispenser cathode which is easily manufactured and miniature in size.

It is another object of the present invention to provide an improved reservoir dispenser cathode having an extended and efficient operating lifetime.

The subject matter of the present invention is particularly pointed out and distinctly claimed in the concluding portion of this specification. However, both the organization and method of operation, together with further advantages and objects thereof, may best be understood by reference to the following description taken in connection with the accompanying drawings wherein like reference characters refer to like elements.

### BRIEF DESCRIPTION OF THE DRAWINGS

FIG. 1 is a vertical cross section of a cylindrical dispenser cathode in accordance with the present invention,

FIG. 2 illustrates a first step in the manufacture of a cathode according to the present invention,

FIG. 3 illustrates the dispenser cathode according to the present invention after welding,

FIG. 4 is a cross-sectional view of laser welding apparatus employed according to the present invention,

FIG. 5 is a schematic illustration of a carbonate reduction apparatus employed in accordance with a method aspect of the present invention,

FIG. 6 illustrates the construction of a dispenser cathode in accordance with a second embodiment of the present invention,

FIG. 7 is a schematic representation of a first method for forming a diffuser plug as employed with the FIG. 6 embodiment, and

FIG. 8 is a schematic illustration of a second and alternative method employed in forming the diffuser plug utilized in the FIG. 6 embodiment.

### DETAILED DESCRIPTION OF THE PREFERRED EMBODIMENT

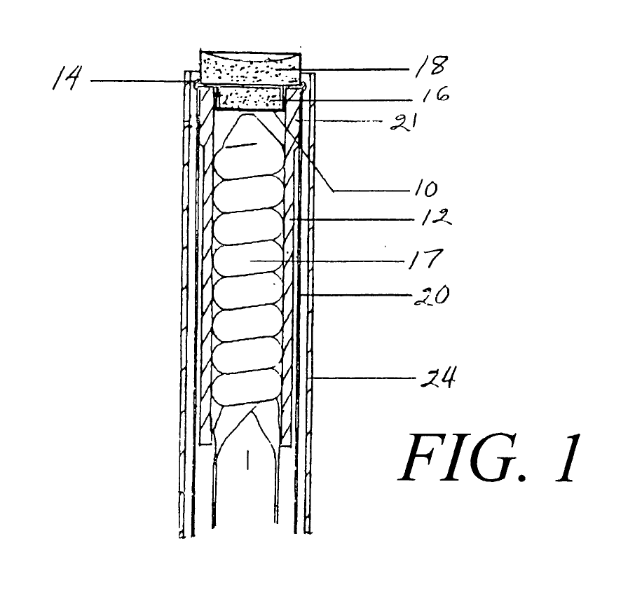

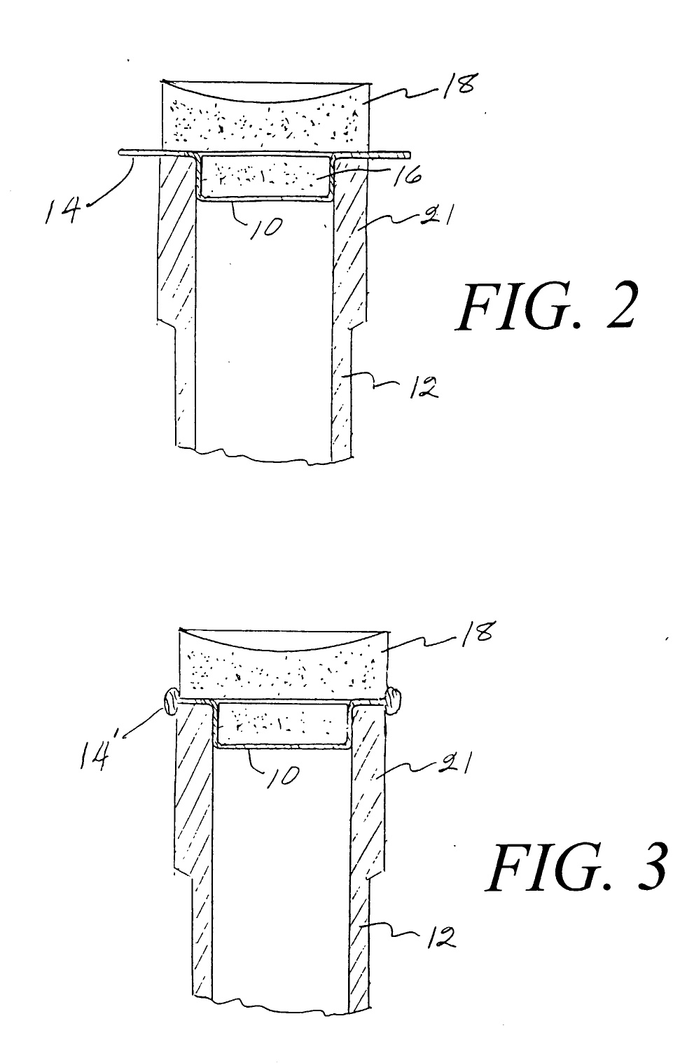

Referring to the drawings and particularly to FIG. 1, a cylindrical reservoir cup 10 is received within and supported by the upper portion of a cylindrical heater body 12 and cup 10 is provided with a radially outwardly extending flange 14 at its upper end which, during the manufacturing stage, extends substantially radially outwardly beyond the circumference of the heater body 12 in the manner illustrated in FIG. 2. The reservoir cup 10 is formed of a refractory material, for example a tungsten-rhenium 75-25 alloy, or platinum, with platinum being preferred because of its drawability in forming the cup. The heater body 12 is suitably formed of molybdenum or other refractory metal, and is provided with a larger radius towards its upper open end forming a hub 21 where it receives the cup 10. Within the heater body 12 is provided a slip-in heater device 17. Within cup 10 is located an emission pellet 16 of a material adapted to supply an electron emissive substance when heated. The pellet 16 preferably comprises a pressed pill of barium oxide mixed with 20% tungsten powder. The emissive material is pressed into the reservoir cup 10 so as to be closely received therewithin.

Just above cup 10 and supported by flange 14 is a diffuser plug 18 comprising a pelletized refractory matrix that is highly porous. This diffuser plug is preferably formed of 20 to 25 micron tungsten powder mixed with 50% rhenium powder to provide a sinterable cylindrical pellet. After sintering, the upper surface of the plug is sputter coated with osmium or some other emission enhancing material to lower the work function. As will be appreciated by those skilled in the art, operation of heater 17 causes the emission pellet 16 to provide free barium passing through diffuser plug 18 to its upper surface.

Towards the upper end of heater body 12 and particularly the larger hub portion 21 thereof, such hub portion is received within and spot welded to refractory metal cylindrical sleeve or skirt 20 extending downwardly in surrounding and spaced relation to the heater body and past the lower end thereof. The support sleeve 20 is rolled molybdenum-rhenium in the specific embodiment illustrated. A heat shield 24 comprising a cylinder is disposed in surrounding spaced relation to sleeve 20. Heat shield 24 extends upwardly in surrounding relation to the cathode structure, but short of the upper part of diffuser plug 18.

Heater body 12 is suitably cold-headed from tubing on a high speed press to provide the upper hub portion 21. The heater body accomplishes an important function in that it retains the heat of the filament during operation of the cathode, greatly reducing the required heater temperature during operation of the cathode. Moreover, in addition to conveying heat from the filament to the cup 10 during cathode operation, the heater body absorbs heat during the peripheral welding operation between the heater body, flange 14, and the diffuser plug 18, as hereinafter more fully described. The heater body decreases power consumption during operation inasmuch as heat is more efficiently conveyed to the electron emissive material 16 and diffuser plug 18.

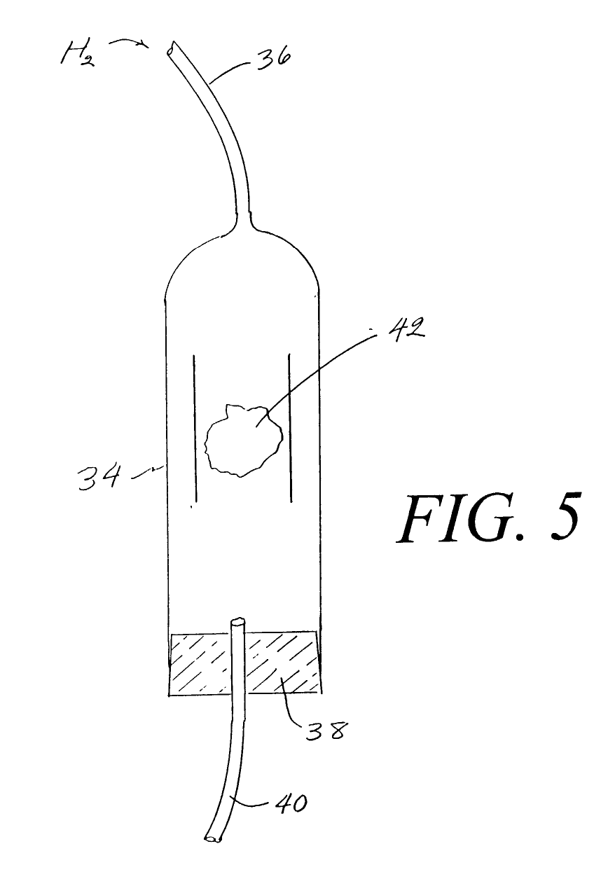

The emission material 16 is formed by reducing barium carbonate, BaCO₂, in hydrogen in an inductively heated tube 34 illustrated in FIG. 5. The induction heating coil for surrounding tube 34 is not shown in the drawing. Tube 34 is provided with a hydrogen inlet 36 and a stopper 38 at the bottom of the tube, the latter receiving a hydrogen outlet pipe 40. Barium carbonate 42 is suitably located in a boat within the tube and is heated by induction heating so that barium oxide, BaO, is formed as the reaction product. The upper inlet 36 is sealed off, and the tube is transferred to a glove box to prevent contact with air after which stopper 38 and the barium oxide powder are removed. The barium oxide is mixed with approximately 20% tungsten powder and pressed into reservoir cup 10 as the emission material 16 in FIG. 1. Only the top of the emission material is exposed to the air, thus avoiding contamination of the barium oxide material.

The cup 10 is also of a diameter to be directly received within the upper hub portion of heater body 12. The cup 10 may be formed of a tungsten-rhenium alloy, or of platinum. The cup is pressed into the shape illustrated for receiving the emission material 16 and is open upwardly to be adjacent diffuser plug 18 in the finished construction.

Around the upper opening in cup 10, the cup is formed with an outwardly extending radial flange 14 adapted to rest upon the upper peripheral surface of heater body 12, while in turn supporting the peripheral region of diffuser plug 18. In the illustrated construction, the diffuser plug is slightly larger in diameter than the emission material 16 and is suitably equal in diameter to the upper hub portion 21 of heater body 12. However, the outwardly extending radial flange is of-substantially greater diameter and desirably extends outwardly by a distance approximately equal to thickness of upper hub portion 21 of the heater body. The flange 14, where it extends radially outwardly, is employed as fusible welding material for securing the component parts together in hermetically sealed relation, and while the exact diameter is not specific, a flange which supplies ample welding metal is desired. The flange member 14 is preferably unitary with cup 10. However, it can comprise an at least initially separate annular member, i.e., a flat annular radial ring or washer which extends outwardly and provides support for plug 18 as well as supplying the welding material. In such case, cup 10 may also be sealingly supported from underneath.

The components are assembled together as illustrated in FIG. 2, after which the seam between the three components 21, 14 and 18 is continuously laser welded employing a laser welder in a rotational mode such that a relatively large, continuous weld bead 14′ is peripherally formed from the flange material around the seam between the components as illustrated in FIG. 3.

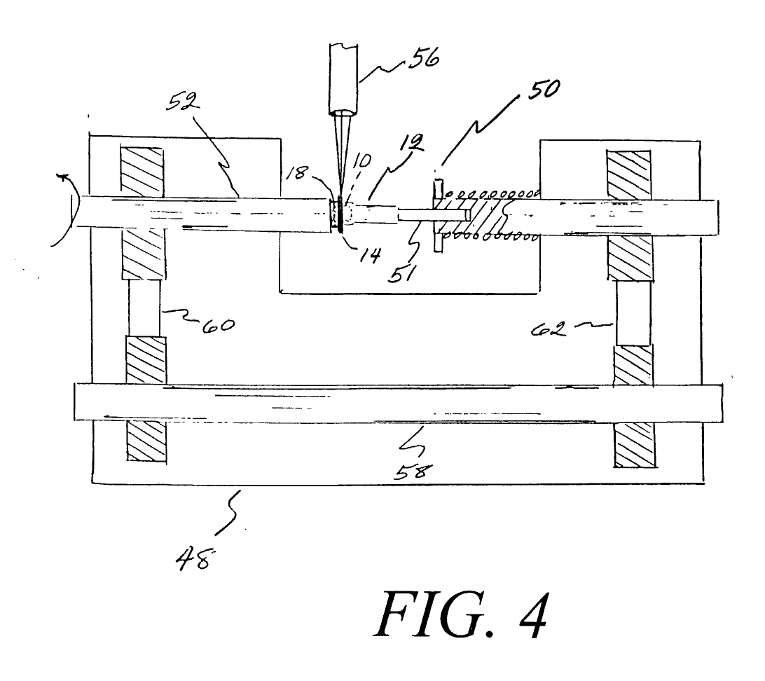

Referring to FIG. 4, a fixture 48 is utilized for holding components 12, 10 and 18 on the same center for rotation about the common axis of chuck 50. Spindle 52 supports diffuser plug 18, while heater body 12 is received on peg 51 extending from chuck 50. Laser 56 is accurately directed at the seam between the heater body 12 and the flange 14 of the cup and is empowered to melt the flange as the assembly is rotated via drive shaft 58 by means not shown for rotating chuck 50 and spindle 52 at the same speed via intershaft belts 60 and 62 as illustrated. Chuck 50 is spring-loaded to bias the components 12, 10 and 18 against one another.

The complete weldment 14′ (in FIG. 3) provides a considerable bead of material that completely hermetically seals the cup to the diffuser plug 18. Heat as would otherwise be destructive to the emission material 16 and plug 18 during welding is largely conducted away by flange 14 and hub portion 21 of the heater body, and moreover, the continuous weldment bead supplies filler material which fills in up along the side of the diffuser plug enhancing a complete hermetic seal. Therefore, when the device is raised in temperature by heater 17 (FIG. 1) an adequate vapor pressure of free barium is built up within the cup and passes through the plug 18 to supply a low work function emission at the surface on the upper side of the plug without escaping at the side of the plug.

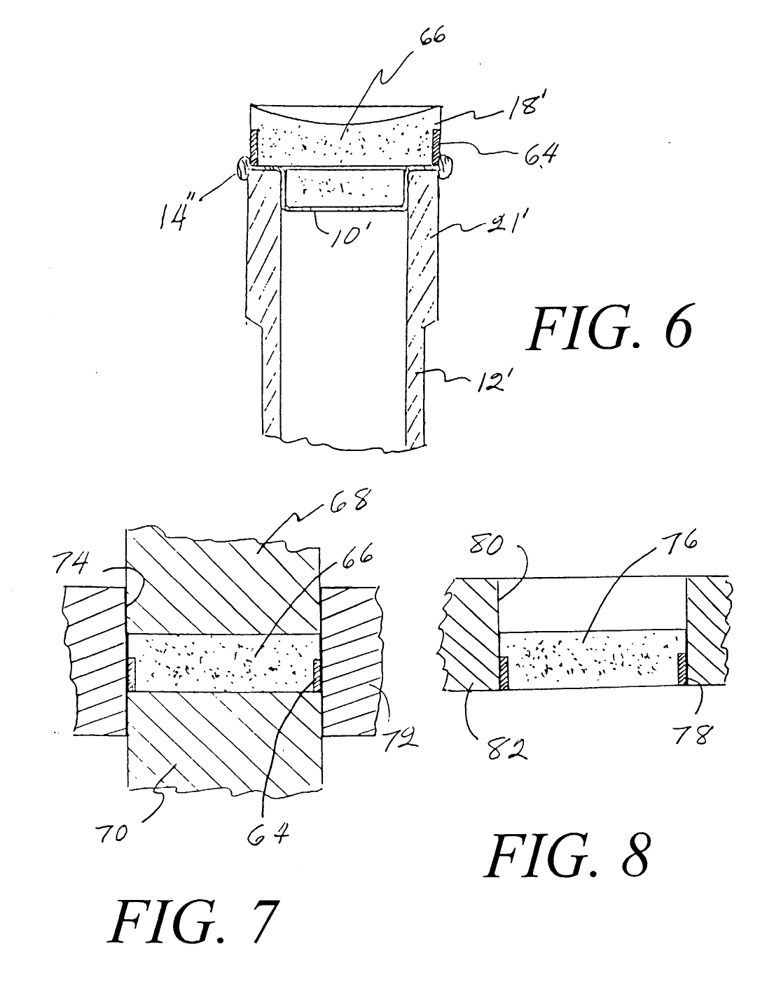

A second, preferred construction for the diffuser plug is illustrated in FIGS. 6-8 wherein elements corresponding to the previous embodiment are given primed reference numerals. Referring to FIG. 6, diffuser plug 18′ is provided with a thin, cylindrical ring or band 64 disposed in surrounding relation to at least the lower part of the diffuser plug. In the illustrated embodiment, the ring 64 extends upwardly from the bottom of the diffuser plug 18′ approximately two-thirds the distance to the upper peripheral surface, and the internal, porous material of the plug is indented, as illustrated, to closely receive such ring whereby the entire diffuser plug has an overall common cylindrical side wall. In this embodiment, the plug 18′, except for the ring 64, is formed from 50% tungsten powder and 50% rhenium powder, while the ring 64 is formed of rhenium, and, as hereinafter more fully explained, is disposed in bonded relation to the interior of the plug. The weldment 14″, formed from the flange of cup 10, is accomplished as described in regard to the previous embodiment but in this embodiment, the weld bead 14″ is principally or mostly adhered to ring 64 rather than the rest of the plug.

A first method of forming the diffuser plug 18′ is illustrated in FIG. 7. First, the two powders, i.e., tungsten and rhenium for the plug pellet 66 are pressed in a double-punch and die set 68-70-72, the ring 64 first being inserted within the cylindrical aperture 74 of die 72 for resting on lower punch 70. High pressure, e.g. 40 to 50 tons per square inch, is used to press the powders by means of downward force on punch 68. As a result, a compact pellet is formed having ring 64 attached circumferentially to the lower portion thereof. The pellet-ring matrix is sintered at 1900 degrees Celsius which accomplishes partial welding together of the particles of tungsten and rhenium while the ring 64 is tightly adhered onto the sintered pellet 66 and welds or bonds to it. The completed pellet, upon sputter coating the top with osmium or another emission enhancing material, becomes the diffuser plug for the cathode. During the procedure as illustrated in FIG. 4, the ring 64 is then secured via laser welding to the remainder of the device and in particular to the cup flange. It is of advantage to weld the cup flange to ring 64 in this manner since the latter is less subject to being stressed in the procedure as compared with the interior of the plug. The construction of FIGS. 6 and 7 at the same time maintains the extremely small, miniaturized cathode construction of the first embodiment, e.g. a cathode of approximately 0.08 inches in diameter.

A further method of construction for the diffuser plug is illustrated in FIG. 8, and this method is also efficacious and in some cases superior to the construction method described in connection with FIG. 7. In the embodiment of FIG. 8, the plug 76 (which corresponds to plug 66 in the previous embodiment) is formed from 50% tungsten powder and 50% rhenium powder. After mixing of the powder, the mixture is poured into a conventional punch-die set and pressed at high pressures, e.g. 40 to 50 tons per square inch, and is then sintered at approximately 1900 degrees Celsius. A ring or collar 78, preferably formed of rhenium, is pressed over the pellet 76 with an interference fit, on the lower end of the cylindrical pellet. The pellet 76 having the ring on the lower end thereof, is then positioned within a cylindrical hole 80 in a quartz block 82 wherein the ring fits tightly within the quartz. The quartz and matrix are heated to near sintering temperatures, but not to a temperature high enough as would melt the quartz. The combination is held at high temperature until a diffusion bond or weld between the ring 78 and the porous sintered material of pellet 76 is formed. The quartz constrains the ring because it has a lower expansion rate than the ring, thus maintaining substantial pressure at the interface between the porous pellet material 76 and the ring 78 for forming a diffusion weld therebetween. Then, the ring is welded to the reservoir-heater body in the manner illustrated in FIG. 6. This construction produces such a tight bond as between the pellet material 76 and ring 78 that a wider range of materials can be employed. Thus, instead of tungsten and rhenium powder for pellet 76, a tungsten-osmium mixture or straight tungsten powder can be utilized and die pressed into pellets. However, tungsten-rhenium powder is preferred.

As hereinbefore indicated, a very miniaturized cathode is produced according to the present invention. In a specific example, the cathode was 0.08 inches in diameter, producing a beam that is compressible to 0.02 inches. The cup material including the flange was approximately 4 mils in thickness while a surrounding metal band when used was about 5 mils in thickness. The power dissipation was less than two watts with an emission current of 5 amps per square centimeter. Warm-up time was approximately 6 seconds when overvoltage was applied initially to the heater. It is seen the cathode according to the present invention solves the problem of sealing to the diffuser plug without destruction thereof, thereby providing a miniaturized and economically manufactured device.

While preferred embodiments of the present invention have been shown and described, it will be apparent to those skilled in the art that many changes and modifications may be made without departing from the invention in its broader aspects. The appended claims are therefore intended to cover all such changes and modifications that fall within the true spirit and scope of the invention.

1. A reservoir dispenser cathode adapted to provide high electron beam current, said cathode comprising:
a cup for receiving a material adapted to decompose when heated to produce a product having a low work function, and
a diffuser plug superposed over said cup and through which said low work function product is supplied,
said cup being provided with an outwardly extending radial flange member wherein said flange member at its outer periphery integrally comprises a weldment bead providing a seal with said diffuser plug.

2. The cathode according to claim 1 further comprising means for heating said cup including a cylindrical member receiving said cup and joined thereto by said weldment bead.

3. The cathode according to claim 1 wherein said material adapted to decompose when heated comprises barium oxide.

4. A reservoir dispenser cathode adapted to provide high electron beam current, said cathode comprising:
an upwardly open refractory thin metal cup for receiving therewithin a barium bearing compound material adapted to decompose when heated, said cup having a lower material receiving portion and an upper peripheral flange member at the upper opening end of said cup, said flange member extending peripherally outwardly from said cup, and
a porous refractory metal body adjoining said flange member in closing relation to the upper opening of said cup and adapted to pass barium to the outer surface thereof,
said flange member at its outer periphery integrally comprising a continuous circumferential weldment bead joining said flange member and said refractory metal body in hermetically sealing relation.

5. The cathode according to claim 4 further including a refractory metal, filament-receiving body disposed around said cup and joined to said flange member by said circumferential weldment bead.

6. The cathode according to claim 4 wherein said porous metal body is formed of tungsten and rhenium.

7. The cathode according to claim 6 wherein said porous metal body is formed of substantially equal parts tungsten and rhenium in sintered powder form.

8. The cathode according to claim 4 wherein said porous metal body is provided with an enclosing metal ring to which said weldment bead is immediately joined.

9. A reservoir dispenser cathode adapted to provide high electron beam current, said cathode comprising:
a cup for receiving a material adapted to decompose when heated to produce a product having a low work function, and
a diffuser plug superposed over said cup, said plug comprising a porous metal body through which said low work function product is provided and a cylindrical metal member in circumferentially enclosing relation to at least part of the lateral exterior of said porous metal body and integrally joined thereto,
wherein said cup is welded to said cylindrical metal member.

10. The method of manufacturing a reservoir dispenser cathode comprising:
forming a cup adapted to receive a material that produces an electron emissive substance when heated, including providing said cup with an outwardly extending radial flange member, and
joining said flange member to a porous body by circumferentially welding said flange member to said porous body employing said flange member as the welding material.

11. The method according to claim 10 including circumferentially enclosing said porous body with a metal band prior to welding.

12. The method according to claim 10 comprising simultaneously joining a supporting heater body to said flange member.

13. The method according to claim 12 wherein circumferentially welding said flange member comprises continuous laser welding of the seam between said cup and said heater body.

14. The method of manufacturing a reservoir dispenser cathode comprising the steps of:
forming a metal cup for location between a porous refractory metal body positioned adjacent the upper open end of said cup and a tubular refractory metal body therebelow in surrounding relation to said cup, including providing the upper end of said cup with a radial, outwardly extending flange member which initially extends farther outwardly than the outer diameter of said tubular refractory metal body by a distance comparable to the thickness of said tubular refractory metal body so that said flange member is supported by said tubular refractory metal body and supports said porous refractory metal body, and
circumferentially and continuously welding said flange member to said tubular metal body and said porous metal body so that said flange member extending beyond said tubular metal body forms a continuous weldment bead in surrounding relation between said tubular metal body, said flange member and said porous metal body to form a hermetic seal between said cup and the porous metal body for electron emissive material from said cup.

15. The method according to claim 14 wherein said welding step comprises continuous laser welding the seam between said flange member and said tubular metal body.

16. The method according to claim 15 including rotating said cup and said refractory metal body on a common axis during welding.

17. The method according to claim 15 including bonding said refractory metal body within a cylindrical metal band prior to welding.

18. The method of manufacturing a reservoir dispenser cathode comprising:
forming a metal cup and providing therewithin a material that produces an electron emissive substance when heated,
forming a diffuser plug including porous material for passing said electron emissive material therethrough, including joining a metal ring in banded circumferential relation to said porous material of said plug, and
welding said metal ring to said cup.

19. The method of manufacturing a reservoir dispenser cathode comprising the steps of:
forming a metal cup for location between a diffuser plug for positioning adjacent the upper open end of said cup and a tubular refractory metal body therebelow in surrounding relation to said cup, including joining a thin metal ring in circumferentially enclosing relation to said plug, and providing the upper end of said cup with a radial, outwardly extending flange member so that said flange is supported by said tubular refractory metal body and supports said diffuser plug, and
circumferentially and continuously welding said flange member to said tubular metal body and said metal ring providing a hermetic seal between said cup and said diffuser plug for electron emissive material from said cup.

20. The method according to claim 19 wherein said diffuser plug with said surrounding metal ring is raised to a high temperature within a cylindrical aperture in a quartz block prior to assembly with said cup to bond said metal ring to said diffuser plug.

21. The method according to claim 19 including forming said diffuser plug from a mixture of tungsten and rhenium, and forming said ring of rhenium.
